(19) United States
(12) Patent Application Publication
(10) Pub. No.: US 2022/0220749 A1
(43) Pub. Date: Jul. 14, 2022

(54) SEALED ACOUSTIC-INSULATION LAMINATE SYSTEM

(71) Applicant: BOSTIK SA, Colombes (FR)

(72) Inventors: Jérémy BECQUET, Coubert (FR); André MAYER, Coubert (FR)

(21) Appl. No.: 17/605,279

(22) PCT Filed: Apr. 24, 2020
(86) PCT No.: PCT/FR2020/050711

§ 371 Date: Oct. 21, 2021

(30) Foreign Application Priority Data
Apr. 26, 2019 (FR) 1904483

(51) Int. Cl. E04F 15/20; B32B 3/30; B32B 5/16; B32B 7/12; B32B 27/32; B32B 7/02; E04F 15/02; E04F 15/10

(52) U.S. Cl. CPC E04F 15/206; B32B 2307/102; B32B 5/16; B32B 7/12; B32B 27/32; B32B 7/02; E04F 15/02188; E04F 15/107; E04F 15/105; E04F 15/0215; B32B 2307/7265; B32B 2471/00; B32B 2307/72; B32B 2307/732; B32B 2264/0207; B32B 3/30

(57) ABSTRACT

The invention relates firstly to a waterproof laminated sound insulation system, in particular for flooring. This system provides sound insulation, in particular against impact noise, in compliance with current regulations, and also satisfactory pressure resistance and satisfactory deformability. The invention also relates to a kit comprising the waterproof laminated system, to the use of fillers having a density of less than 1.2 g/cm³ in an adhesive composition for increasing the sound insulation of floors, and to the method of laying a waterproof laminated sound insulation system.

### TECHNICAL FIELD

The present invention relates to the field of the sound insulation of buildings, in particular of floors. The present invention relates to a waterproof laminated sound insulation system, in particular for flooring, and to a kit comprising same. This system provides sound insulation, in particular against impact noise, in compliance with current regulations, and also satisfactory pressure resistance and satisfactory deformability.

### TECHNICAL BACKGROUND

In order to improve occupant comfort and reduce noise nuisance, regulatory standards exist relating to soundproofing—or acoustic or sound insulation—of buildings. Sound insulation makes it possible in particular to reduce, or even eliminate, environmental noise such as that linked to motor vehicle traffic, and also to reduce, or even eliminate, the transmission of noise through the floor. These standards relate both to the construction of new buildings and the renovation of existing buildings. For example, the first French regulations relating to the acoustics of new buildings date from 1969. These regulations were subsequently modified by the decree of Oct. 28, 1994, then by the decree of Jun. 30, 1999. The French standards currently in force are the NF EN ISO 12354-1, 12354-2 and 12354-3 standards.

Reducing the transmission of noise through the floor, especially impact noise such as footsteps and objects being dropped, is particularly important in private apartment buildings, especially in rooms with floor coverings which absorb little or no noise, such as tiling. At present, the regulations recommend installing sound insulation systems under tiled flooring for obtaining a satisfactory acoustic performance, for example a reduction of at least 18 dB.

Various sound insulation systems for flooring are known.

Application FR 3048712 A1 relates to a waterproof sound insulation system in the form of boards intended to be positioned on a substrate and directly under tiling. This system consists of an insulating board made up of one or more layers firmly attached to one another and coupled to a waterproof part.

Application WO 2010/105857 A1 relates to an insulating mat for sealing and decoupling and for footfall insulation, which is impermeable to water. This mat comprises several layers in the following order: a layer of woven or nonwoven fabric; a first layer of plastic film; a second layer of plastic film comprising a contiguous flat base surface area and stamped features on one side, and also cavities; and a layer of woven or nonwoven fabric. The contiguous flat base surface area of the second plastic film layer is joined to the first layer of plastic film. The features are filled with a filler, the filler preferably consisting of quartz sand and a binder.

Application EP 2812512 A2 relates to an insulation batt comprising a continuous plastic layer having open cups on one side and a covering layer placed on the plastic layer. The cups can be filled with a hard absorbent material such as, for example, expanded clay.

Although the known systems increase the sound insulation of the floors comprising them, these systems do not necessarily make it possible to achieve completely satisfactory sound insulation performance. The provision of systems that have improved performance is sought. However, good acoustic performance should not be achieved at the expense of the other desirable properties of these systems, such as for example flexibility and deformability, ease of handling, durability, ease of packaging, weight, thickness, manufacturing costs, pressure resistance and load borne, etc.

There is therefore a real need to provide a system for the sound insulation of floors, allowing a good reduction in the transmission of noise and in particular of impact noise (for example of at least 18 dB, preferably of at least 19 dB, very preferentially of at least 20 dB). There is also a need to provide a system having a flexibility and a deformability that facilitate its use, in particular as an intermediate between the substrate, in particular a concrete screed, and a floor covering, in particular tiling. There is also a need to provide a system which is easy to handle and which can be stored in a form which facilitates the storage and delivery thereof. Finally, there is also a need to provide a system whose production costs are reasonable, without however reducing the durability thereof.

### SUMMARY OF THE INVENTION

The invention relates firstly to a waterproof laminated sound insulation system for flooring comprising a first outer layer, a second outer layer, and a waterproof intermediate layer interposed between the two outer layers; said intermediate layer being a preformed plastic layer having a series of cavities on one of its two surfaces; said cavities comprising a resilient material having a Shore A hardness of from 50 to 90.

In some embodiments, the resilient material is chosen from the group consisting of rubber, cork, and mixtures thereof. In particular, the resilient material is in the form of rubber beads having a weight-median particle size (d50) of from 0.1 to 2 mm.

In some embodiments, the cavities further comprise a binder material.

In some embodiments, the waterproof laminated sound insulation system further comprises an adhesive layer obtained by applying an adhesive composition to one of the outer layers and/or to the substrate.

In some embodiments, the adhesive composition comprises fillers having a density of less than 1.2 g/cm³. In particular, the fillers having a density of less than 1.2 g/cm³ are expanded glass beads.

In some embodiments, the waterproof intermediate layer is obtained from a flat layer shaped by a forming process; preferentially by a thermoforming process.

In some embodiments, the waterproof intermediate layer comprises a plastic material chosen from the group consisting of polyolefins, polyurethane, polyvinyl chloride, ethylene/vinyl acetate copolymer, ethylene-propylene-diene terpolymer or mixtures thereof; preferentially from the group consisting of polyethylene, polypropylene, or mixtures thereof.

In some embodiments, the waterproof intermediate layer has a thickness of from 1 mm to 9 mm; preferentially from 2 mm to 7 mm; very preferentially from 3 mm to 6 mm.

In some embodiments, the outer layers each have a thickness of from 5 μm to 5 mm; preferentially from 10 μm to 3 mm; very preferentially from 50 μm to 2 mm.

In some embodiments, the outer layers are firmly attached to the waterproof intermediate layer, preferentially the outer layers are heat-sealed to the waterproof intermediate layer.

The invention also relates to a sound insulation kit comprising a waterproof laminated system, as defined opposite, comprising a first outer layer, a second outer layer, and a waterproof intermediate layer interposed between the two outer layers; said intermediate layer being a preformed plastic layer having a series of cavities on one of its two surfaces; said cavities comprising a resilient material having a Shore A hardness of from 50 to 90; and to an adhesive composition.

The invention also relates to the use of fillers having a density of less than 1.2 g/cm³ in an adhesive composition to increase the sound insulation of floors.

The invention also relates to a method for laying a waterproof laminated sound insulation system, comprising the following steps: providing a waterproof laminated system, as defined opposite, comprising a first outer layer, a second outer layer, and a waterproof intermediate layer interposed between the first outer layer and the second outer layer; said intermediate layer being a preformed plastic layer having a series of cavities on one of its surfaces; said cavities comprising a resilient material having a Shore A hardness of from 50 to 90; determining the orientation of the waterproof laminated system; applying an adhesive composition to the lower outer layer to be positioned facing the substrate or directly on the substrate; laying the waterproof laminated system on the substrate and adhering the lower outer layer to the substrate; applying an adhesive mortar to the upper outer layer; and laying the floor covering and adhering it to the top outer layer.

The present invention makes it possible to overcome the drawbacks of the prior art. It more particularly provides a sound insulation system for flooring that has a satisfactory acoustic performance, and that makes it possible in particular to obtain a reduction in noise transmission of at least 18 dB.

In addition, the system of the invention also has one or preferably several advantages, in particular a reduced thickness, satisfactory impermeability, flexibility and deformability and therefore great ease of handling both in terms of storage, delivery and laying.

### BRIEF DESCRIPTION OF THE FIGURES

FIG. 1 represents a photograph of the surface of the first outer layer of the waterproof laminated system.

The figure represents a photograph of the edge (in cross section) of the waterproof laminated system.

### DETAILED DESCRIPTION

The invention is now described in greater detail and in a nonlimiting manner in the description that follows.

Waterproof Laminated System

In a first aspect, the present invention relates to a waterproof laminated sound insulation system for flooring. The acoustic performance of this system complies with the current regulatory standards, and makes it possible to significantly reduce the transmission of noise, in particular when it is interposed between the substrate and the floor covering, preferably by at least 18 dB, preferentially by at least 19 dB, very preferentially by at least 20 dB. This waterproof laminated system can be used with any type of floor covering, including tiling, wooden flooring, flexible floors (for example made of PVC).

In the field of construction, a sound insulation system can also be denoted by various terms such as for example sound insulation “board”, “batt” or “underlay”.

The system according to the present invention is a multilayer system comprising a first outer layer, a second outer layer, and a layer interposed between these two outer layers.

The Waterproof Intermediate Layer

The system according to the present invention comprises a waterproof intermediate layer, interposed between the two outer layers.

This layer is a preformed layer. This preformed layer is typically obtained from a flat layer shaped by a suitable forming process, preferentially a thermoforming process. For illustration, a layer preformed by thermoforming can be obtained by the provision of a flat layer and the heating thereof, so as to to soften the material composing it, followed by laying on a mold and suction to enable the deformation of the material, in order to to match the shape of the mold. This layer is therefore not perforated. This layer is therefore devoid of perforations.

This layer is a plastic layer. This layer therefore comprises a plastic material; preferentially a plastic material chosen from the group consisting of polyolefins, polyurethane, polyvinyl chloride, ethylene/vinyl acetate copolymer, ethylene-propylene-diene terpolymer or mixtures thereof. The polyolefins can be chosen from the group consisting of polyethylene, polypropylene, or mixtures thereof. The polyethylene and/or polypropylene can be high-density or low-density polymers.

This layer may have a thickness of from 1 mm to 9 mm; preferentially from 2 mm to 7 mm; very preferentially from 3 mm to 6 mm.

This intermediate layer has two surfaces, each surface being in contact with a respective outer layer. This layer has a series (a set) of cavities, the openings of which are located on one of its two surfaces, and therefore preferably a series of corresponding projections on the other surface. The cavities can vary in number and size, depending on the applications envisaged. These cavities are formed during the shaping of the layer by the forming process. These cavities do not form perforations.

Each cavity can be of any suitable shape. Each cavity can be of circular, oval, triangular, square, pentagonal or hexagonal shape, or of any other suitable shape; preferentially the cavity is of circular shape. In one embodiment, all the cavities are of the same shape, preferentially all the cavities are of circular shape.

Each cavity can have a maximum dimension (orthogonal to the height of the cavity) of from 1 to 50 mm, preferentially from 2 to 20 mm, very preferentially from 5 to 10 mm. When the cavity is of circular shape, the diameter is from 1 to 50 mm, preferentially from 2 to 20 mm, very preferentially from 5 to 10 mm.

Each cavity can have a height (or depth, perpendicular to the mid-plane of the intermediate layer) of from 1 to 10 mm, preferentially from 2 to 8 mm, very preferentially from 3 to 7 mm. In one embodiment, all of the cavities have substantially the same height.

Each cavity can define an internal volume of from 3.14 to 2826 mm³, preferentially from 50 to 750 mm³, very preferentially from 100 to 400 mm³.

Each cavity preferentially has a flat bottom. In one embodiment, the preformed layer therefore comprises two parallel surfaces. The first surface is formed by the sections of the layer located between the cavities, which gives it a perforated appearance. The second surface is formed by the sections of the layer corresponding to the bottom of the cavities, which gives it a discontinuous appearance.

The series of cavities can form a regular pattern. In one embodiment, the cavities can form an arrangement in a square, rectangular, centered square, centered rectangular, triangular, etc. lattice.

All the cavities can represent from 20% to 80%, preferentially from 30% to 70%, very preferentially from 40% to 60%, of the total surface area of the intermediate layer.

The adjacent cavities may be spaced apart, along their smallest distance, by 0.5 to 10 mm, preferentially by 1 to 6 mm, very preferentially by 2 to 4 mm.

Outer Layers

The system according to the present invention comprises a first outer layer and a second outer layer, between which the waterproof intermediate layer is interposed. The outer layers are flat layers. The outer layers may be identical or different. In one embodiment, no layer is interposed between the waterproof intermediate layer and each of the outer layers.

In one embodiment, the outer layers are firmly attached to the waterproof intermediate layer, preferentially the outer layers are heat-sealed to the waterproof intermediate layer.

In one embodiment, the first outer layer is securely affixed to the first surface of the intermediate layer formed by the sections located between the cavities. The first outer layer therefore seals the cavities.

In one embodiment, the second outer layer is securely affixed to the second surface of the intermediate layer formed by the sections of the layer corresponding to the bottom of the cavities.

Any suitable process can be used, in particular a heat-sealing process.

Each outer layer may be selected from the group consisting of a woven layer or a nonwoven layer; preferentially the outer layer is a nonwoven layer or alternatively the outer layer is a woven layer. The outer layers may comprise mineral fibers, fibers of animal origin, plant fibers, synthetic fibers, or mixtures thereof. For example, the mineral fibers may be glass fibers, asbestos fibers, or mixtures thereof; the fibers of animal origin may be silk, wool, or mixtures thereof; the plant fibers may be cotton, flax, hemp or mixtures thereof; the synthetic fibers may be polyamide, polyester (polyethylene terephthalate, polybutylene terephthalate, polyvinyl chloride, polypropylene, polyethylene, etc.) or mixtures thereof. In one embodiment, the two outer layers are nonwoven layers.

Each outer layer may have a thickness of from 5 μm to 5 mm, preferably from 10 μm to 3 mm, very preferentially from 50 μm to 2 mm.

Each outer layer may further comprise a reinforcing weft, preferably a reinforcing weft made of glass fibers. This high-strength weft increases the impact resistance.

Orientation

The orientation of the system may vary depending on its use. For example, when the system according to the invention is used as an intermediate between the substrate, in particular the concrete screed, and the floor covering, in particular tiling, the openings of the cavities of the intermediate layer can be oriented downward or upward.

In a preferred embodiment, the openings of the cavities may oriented upward (and the bottom of the cavities downward). The first outer layer then forms the upper outer layer, on which the floor covering will be laid, in particular the tiling. The second outer layer forms the lower outer layer, which will be laid on the substrate, in particular the concrete screed. This orientation has the advantage of limiting contact with the substrate and of minimizing the transmission of vibrations.

In an alternative embodiment, the openings of the cavities may oriented downward (and the bottom of the cavities upward). The second outer layer then forms the upper outer layer, on which the floor covering will be laid, in particular the tiling. The first outer layer forms the lower outer layer, which will be laid on the substrate, in particular the concrete screed.

Resilient Material

The cavities comprise a resilient material or a mixture comprising a resilient material. The term “resilient material” is understood to mean a material capable of absorbing energy, following the deformation thereof under the effect of an impact, limiting or even blocking the transmission of vibrations and therefore indirectly the transmission of noise. Since the cavities are permanently sealed by the first outer layer, the system therefore contains a resilient material.

The resilient material is a material having a Shore A hardness of from 40 to 90, preferably from 45 to 80, very preferentially from 50 to 75. The material may have a Shore A hardness of around 70. The Shore A hardness corresponds to the hardness of soft materials. The Shore A hardness can be measured by standard ISO 7619-1 2010.

The resilient material may be chosen from the group consisting of rubber, cork, and mixtures thereof; preferentially the resilient material is rubber.

In one embodiment, the resilient material is in the form of beads, in particular in the form of rubber beads.

The beads may have a weight-median particle size (d50) of from 0.1 to 2 mm; preferentially from 0.2 to 1.5 mm; very preferentially from 0.3 to 0.8 mm; in particular from 0.3 to 0.4 mm, from 0.4 to 0.5 mm, from 0.5 to 0.6 mm, from 0.6 to 0.7 mm or from 0.7 to 0.8 mm. The weight-median particle size (d50) analysis can be performed by laser particle size analysis. In one embodiment, the beads have a weight-median particle size (d50) of around 0.45 mm.

The rubber beads may have a density of from 0.8 to 1.4 g/I; preferentially from 0.9 to 1.3 g/I; very preferentially from 0.9 to 1.2 g/I.

The rubber may be a natural rubber and/or a synthetic rubber. The synthetic rubber may be chosen from the group consisting of styrene-butadiene and ethylene-propylene-diene terpolymer. The rubber may be recycled rubber, for example obtained in particular from used tires. The recycling of used tires has the advantage of reducing the production costs of the system according to the invention, and of reducing the amount of waste.

In another embodiment, the resilient material is cork. The cork may be chosen from the group consisting of raw cork (no treatment except steaming) or expanded cork (expanded for example by heating at high temperature). A composite material comprising cork is available in particular under the trade name Hexpol® TPE from Lifocork.

The cavities may comprise exclusively (100%) resilient material. Alternatively, the mixture used to fill the cavities may comprise at least 10%, preferentially at least 50%, very preferentially at least 80% of resilient material, by total weight of the mixture.

The inventors have demonstrated that this material has the advantage of giving the system a good acoustic performance. In addition, due to its resilient nature and unlike rigid materials such as sand, this material does not excessively stiffen the system. This system therefore retains good flexibility and good deformability. These properties facilitate its use, in particular as an intermediate between the substrate and the floor covering. These properties also make this system very particularly easy to handle, in that it can be stored in the form of a roll.

Binder Material

The cavities may further comprise a binder material, mixed with the resilient material. The addition of a binder material advantageously increases the cohesion of the waterproof laminated system. In particular, it makes it possible to bind the resilient materials together and to prevent them from flowing out of the cavities when the laminated system is cut. Preferably, the binder melts during the fastening of the first outer layer to the intermediate layer, resulting in the sealing of the cavities.

The binder material may be a thermoplastic material; preferentially a polyvinyl acetate (PVA), a polyacrylate, an ethylene/vinyl acetate, a polyamide, a polyurethane and mixtures thereof.

The mixture used to fill the cavities may comprise from 1% to 90%, preferentially from 2% to 50%, very preferentially from 5% to 20%, of binder material, by total weight of the mixture.

Other Materials

The cavities may comprise other materials, for example a flame retardant or an intumescent composition.

The flame retardant may be chosen from the group consisting of polybrominated diphenyl ethers (PBDEs), hexabromocyclododecanes (HBCDDs), tetrabromobisphenol A (TBBPA), polybrominated biphenyls (PBBs) and mixtures thereof.

The intumescent composition may be chosen from melamine phosphate or phosphite with pentaerythritol, and mixtures thereof.

The mixture used to fill the cavities may comprise from 0.1% to 20%, preferentially from 0.1% to 10%, very preferentially from 0.1% to 5%, of other materials, by total weight of the mixture.

Adhesive Layer

The system according to the invention may further comprise at least one adhesive layer. This adhesive layer enables the adhesion of the system to the substrate on which it is laid, in particular a concrete screed.

The adhesive composition may be applied just before the laying of the waterproof laminated system. In a preferred embodiment, the adhesive composition may be applied to the substrate on which the system according to the invention will be laid. In alternative embodiments, the adhesive layer may be formed by applying an adhesive composition to the first outer layer and/or the second outer layer, depending on the orientation of the system during installation.

The adhesive composition can be applied during the manufacture of the system according to the invention to form an adhesive layer, which can be covered with a protective layer to be removed before installation. The system is then ready to use and ready to install, after removal of the protective layer. In this embodiment, the sound insulation system according to the invention therefore comprises an upper first outer layer and a lower second outer layer, a waterproof intermediate layer interposed between the two upper and lower layers, at least one adhesive layer covering the lower layer, and optionally a protective layer covering the adhesive layer.

The adhesive composition may be an aqueous adhesive composition.

The adhesive composition may be an aqueous acrylic composition. The acrylic composition may be a ready-to-use composition or may be obtained by prior dispersion of a dry adhesive material in water. The acrylic composition may comprise an adhesive material chosen from the group consisting of an aqueous acrylic polymer, a styrene-acrylic polymer, an ethyl vinyl acetate polymer, or mixtures thereof. The adhesive composition may comprise from 10% to 90%, preferentially from 20% to 85%, very preferentially from 30% to 85%, of adhesive material, by total weight of the adhesive composition at the time of application. The adhesive material may be, for example, polymers available under the trade name Revacryl AE4522 available from Synthomer, which is a specially modified aqueous dispersion of a styrene-acrylic ester copolymer intended. The dispersion contains in particular an anionic emulsifier system and is free from film-forming aids, solvents and plasticizers. Lipaton AE4522 available from SYNTHOMER.

The adhesive composition may comprise silyl-modified polymers, also referred to as modified-silane polymers or silane-terminated polymers; preferentially silane-terminated polyethers; very preferentially methoxysilane-terminated polyethers; for example dimethoxysilane-terminated or trimethoxysilane-terminated polyethers. These polymers can be crosslinked, for example by hydrolysis of silyl ethers. These polymers are generally isocyanate-free. These polymers may be, for example, the polymers available under the trade name MS Polymer® from Kaneka. The adhesive composition may comprise from 10% to 85%, preferentially from 15% to 80%, very preferentially from 20% to 50%, of these polymers, by total weight of the adhesive composition at the time of application. The adhesive compositions may be, for example, adhesive compositions available under the trade name SAX 260 or SAX 303H from Kaneka, Geniosil STPE 10 or STPE 30 from Wacker. Such compositions may further comprise a crosslinking catalyst. The catalyst may be chosen, for example, from the group consisting of aminosilanes (for example N-(2-aminoethyl)-3-aminopropyltrimethoxysilane or 3-aminopropyltrimethoxysilane), amines (for example 1,8-diazabicyclo[5.4.0]undec-7-ene or 1,5-diazabicyclo[4.3.0]non-5-ene) or organometallic derivatives, in particular organic derivatives of iron, of divalent or tetravalent tin (for example Neostann® S-1 or Tib-Kat® 324), of titanium (for example titanium acetylacetonate TYZOR® AA75), of aluminum (for example K-KAT® 5218 aluminum chelate from King Industries). Such compositions may further comprise a plasticizer. The plasticizer may be chosen from the group consisting of benzoic acid derivatives (preferably benzoates), phthalic acid derivatives (preferably phthalates), trimellitic acid derivatives, pyromellitic acid derivatives, adipic acid derivatives (preferably adipates), sebacic acid derivatives (preferably sebacates), fumaric acid derivatives, maleic acid derivatives, itaconic acid derivatives or citric acid derivatives, or polyester derivatives, polyether derivatives, mineral oil hydrocarbon derivatives. The plasticizer may be chosen from the group consisting of phthalates, sebacates, adipates, benzoates phthalates or mixtures thereof. The phthalates may be chosen, for example, from dibutyl phthalate, dioctyl phthalate, dicyclohexyl phthalate, diisooctyl phthalate, diisodecyl phthalate, dibenzyl phthalate, butylbenzyl phthalate or mixtures thereof. Such compositions may further comprise a moisture absorber; preferentially a moisture absorber chosen from the group consisting of vinyltrimethoxysilane, vinyltriethoxysilane, alkoxyarylsilanes (for example GENIOSIL® XL 70 by Wacker), and mixtures thereof. Such compositions may further comprise an adhesion promoter; preferentially the adhesion promoter is of aminosilane type; very preferentially the adhesion promoter is an aminosilane; even more preferentially the adhesion promoter is chosen from the group consisting of N-(2-aminoethyl)-3-aminopropyltrimethoxysilane, 3-aminopropyltrimethoxysilane, or mixtures thereof.

By way of example, the adhesive may comprise from 20% to 60% of silane-terminated polyoxyalkylenes, from 30% to 70% of calcium carbonate, from 0.5% to 5% of desiccant, from 0.1% to 5% of curing catalyst, from 0.2% to 5% of adhesion promoter, and optionally from 0% to 50% in total of colored pigments, plasticizers, dispersants, other fillers, light stabilizers and heat stabilizers, by total weight of the adhesive at the time of application. The silane-terminated polyoxyalkylenes may be composed of two types of methoxyalkylsilane-terminated polyoxypropylene having alkyl groups bearing up to 10 carbon atoms and having a viscosity of from 5 to 10 Pa·s and 10 to 25 Pa·s, respectively (measured at 20° C. and a shear gradient of 1 s⁻¹) in the weight ratio of from 5:1 to 1:5. Application WO 2008/077510 A1 discloses adhesives of this type.

The adhesive composition may also comprise fillers having a density of less than 1.2 g/cm³; preferentially less than 1.1 g/cm³, very preferentially less than 1 g/cm³. These fillers can also have a weight-median particle size (d50) of from 0.2 mm to 4 mm; very preferably from 0.4 to 2 mm; preferably from 0.5 to 1 mm; in particular from 0.5 to 0.6 mm, from 0.6 to 0.7 mm, from 0.7 to 0.8 mm, from 0.8 to 0.9 mm or from 0.9 to 1 mm. The adhesive can comprise from 1% to 40%, preferably from 5% to 30%, very preferably from 10% to 20%, of these fillers, by total weight of the adhesive composition at the time of application. These fillers can be added to any suitable available adhesive composition. These fillers can also replace all or some of the calcium carbonate of the adhesive disclosed in application WO 2008/077510 A1. Preferably, these fillers are expanded glass beads. Expanded glass beads are available under the trade name Poraver®, which comprises recycled glass of 100% mineral origin.

The inventors have demonstrated that the addition of fillers having a density of less than 1.2 g/cm³, and particularly of expanded glass beads, made it possible to improve the acoustic performance of the system according to the invention. A particularly satisfactory acoustic performance is obtained with an adhesive composition comprising expanded glass beads having a weight-median particle size (d50) of from 0.2 mm to 4 mm; very preferentially from 0.4 to 2 mm; preferentially from 0.5 to 1 mm; in particular from 0.5 to 0.6 mm, from 0.6 to 0.7 mm, from 0.7 to 0.8 mm, from 0.8 to 0.9 mm or from 0.9 to 1 mm. The analysis of the d50 particle size by weight of the beads may be carried out by laser particle size analysis.

Kit

In a second aspect, the present invention relates to a sound insulation kit comprising a waterproof laminated system and an adhesive composition.

The waterproof laminated system, as defined opposite, comprises a first outer layer, a second outer layer, and a waterproof intermediate layer interposed between these two outer layers.

The adhesive composition, as defined opposite, may be an aqueous adhesive composition. It may also comprise fillers having a density of less than 1.2 g/cm³. In a preferred embodiment, fillers having a density of less than 1.2 g/cm³ are incorporated into the ready-to-use adhesive composition. In another alternative embodiment, fillers having a density of less than 1.2 g/cm³ are incorporated into the adhesive composition just before application.

The kit according to the present invention may be provided with instructions. These instructions may detail the method of using the system, and in particular the step of applying the adhesive composition to one of the two outer layers or to the substrate, and the step of laying the system on the substrate.

Uses

In a third aspect, the present invention relates to the use of fillers having a density of less than 1.2 g/cm³, for example expanded glass beads, in an adhesive composition to increase the sound insulation of floors. Specifically, the inventors have demonstrated that the incorporation of fillers having a density of less than 1.2 g/cm³ made it possible to increase the sound insulation preferentially by at least 1 dB; very preferentially by at least 2 dB, relative to adhesive compositions that do not comprise such fillers.

Method for Laying the Waterproof Laminated System

The waterproof laminated system according to the present invention can be used according to the method comprising the following steps:

providing a waterproof laminated system comprising a waterproof intermediate layer interposed between the first outer layer and the second outer layer;

determining the orientation of the waterproof laminated system with the cavities oriented upward, the first outer layer being upper and the second outer layer being lower; or alternatively the cavities oriented downward, the second outer layer being upper and the first outer layer being lower;

applying the adhesive composition to the lower outer layer to be positioned facing the substrate, respectively the second outer layer or the first outer layer, or alternatively applying the adhesive composition directly to the substrate;

laying the waterproof laminated system on the substrate and adhering the lower outer layer to the substrate;

applying an adhesive mortar to the upper outer layer; and

laying the floor covering and adhering it to the top outer layer.

### Example

The examples that follow illustrate the invention without limiting it.

Reference Test

Impact noise reduction tests were carried out according to the NBN EN ISO 16251-1 standard of September 2014. The noise is caused by an impact machine as described in said standard.

Sound Insulation Systems

Three sound insulation systems are tested.

Reference system—The first system is a reference acoustic system corresponding to a textile composed of polyester fibers and having a thickness of around 8 mm. This system is not waterproof and does not comprise cavities. This system is marketed under the name Bostik Kit Acoustique, with a Duflot ATH 5231 acoustic underlay.

System (comparison)—The second system is a comparative acoustic system sold under the trade name PCI Pecilastic E by BASF. This system corresponds to the systems described in application WO 2010/105857 A1. The cavities are filled using natural sand.

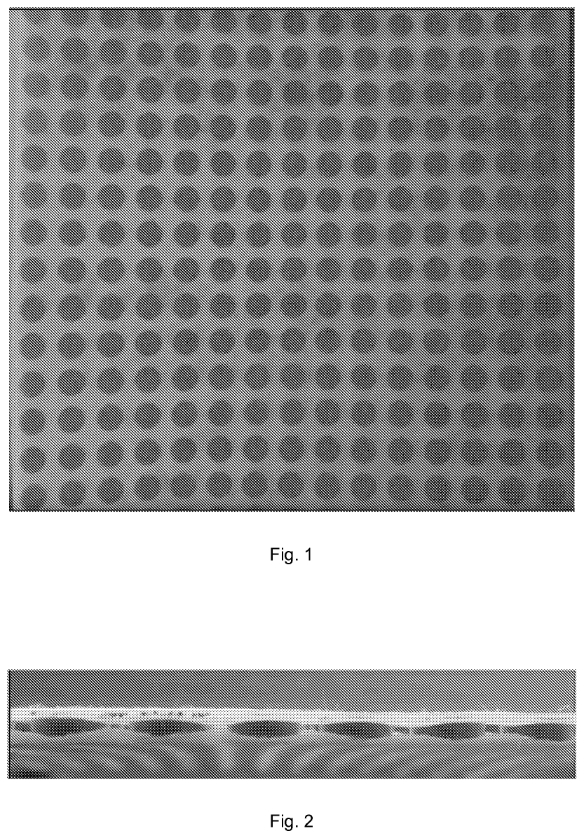

System (invention)—The third system is a system according to the invention comprising a first outer layer, a preformed intermediate layer and a second outer layer, assembled by heat sealing. The first outer layer is a nonwoven layer having a thickness of 0.2 mm and comprising polyester fibers. The preformed intermediate layer is obtained from a layer having a thickness of 0.4 mm and comprising low-density polyethylene. The intermediate layer comprises cavities 8 mm in diameter and 4 mm in height, which represent around 50% of the surface area of the layer. These cavities are filled with a mixture comprising 95% recycled rubber beads (reference 0407 from Kias Recycling—Austria) and 5% ethylene/vinyl acetate (binder). The basis weight of the composition is 600 g/m². The second outer sublayer is a nonwoven layer having a thickness of 0.5 mm and comprising polyester fibers. This third system corresponds to the system according to FIGS. 1 and 2 (photographs). FIG. 1 is a photograph of the surface of the first outer layer (the upper layer). The cavities and their contents are visible by transparency (black circles). FIG. 2 is a photograph of the edge of the waterproof laminated system, the black elements of which correspond to the cavities and their mixture.

Substrate

The installation substrate is a square concrete slab of the “heavy floor” type with sides of 50 cm and a thickness of 5 cm in accordance with standard NF EN 1323 of June 2008.

Floor Covering

The floor covering is formed of square fully vitrified stoneware tiles with sides of 30 cm and a thickness of 8 mm joined using a powdered white jointing mortar of J175 Flex type sold by Bostik.

Laying of the Sound Insulation System on the Substrate

The sound insulation systems tested are fixed to the substrate using a PSA-type adhesive sold under the name Colle Acoustique by Bostik or alternatively an adhesive based on MS polymer sold under the name MSP 200 by Bostik.

PSA adhesive composition (without expanded glass beads)—The PSA adhesive composition comprises 50% Vinnapas EAF 68, 30% Lipaton AE4522, 19.85% water, 0.1% of an acrylic thickener and 0.05% of a preservative, by total weight of the adhesive composition.

PSA adhesive composition (with expanded glass beads)—The PSA adhesive composition comprises 42.5% Vinnapas EAF 68, 25.5% Lipaton AE4522, 16.87% water, 15% of “Poraver” expanded glass beads, 0.08% of an acrylic thickener and 0.05% of a preservative, by total weight of the adhesive composition.

MS adhesive composition (without expanded glass beads)—The adhesive composition based on MS polymer comprises 20% plasticizer, 30% “MS polymer SAX 303H” sold by Kaneka, 47.4% Mickart 1T calcium carbonate, 1% DAMO, 1% VTMO and 0.6% of a Neostan S-1 tin catalyst from Kaneka, by total weight of the adhesive composition.

MS adhesive composition (with expanded glass beads)—The adhesive composition based on MS polymer comprises 20% plasticizer, 30% “MS polymer SAX 303H” sold by Kaneka, 32.4% Mickart 1T calcium carbonate, 15% of “Poraver 0.5-1 mm” expanded glass beads, 1% DAMO, 1% VTMO and 0.6% of a Neostan S-1 tin catalyst from Kaneka, by total weight of the adhesive composition. Two different types of expanded glass beads are added, namely expanded glass beads having a weight-median particle size of from 0.5 to 1 mm and expanded glass beads having a weight-median particle size of from 1 to 2 mm.

The adhesive is applied in beads to the substrate using a B-12 type spatula in an amount of 0.7 kg/m².

Comparison of the Acoustic Performance of the Three Systems

Each of the three systems was laid on the substrate using the PSA adhesive composition. The following results were obtained:

TABLE 1

| System | Acoustic reduction |
|---|---|
| Reference system | −19 dB |
| System (comparison) | −6 dB |
| System (invention) | −18 dB |

The impact noise reduction test demonstrates that the sound insulation system according to the invention has an acoustic performance similar to the reference system and significantly superior to that of a waterproof laminated system of the type of those disclosed in application WO 2010/105857 A1. This improved performance will be associated in particular with the use of a particular filling material for the cavities, that is to say a resilient material having a Shore A hardness of from 50 to 90, in particular rubber beads.

Comparison of the Acoustic Performance of the Adhesive Compositions Used

The various adhesive compositions, with or without expanded glass beads, were tested with the system of the invention. The following results were obtained:

TABLE 2

| Adhesive composition | Acoustic reduction |
|---|---|
| PSA adhesive composition without | −18 dB |
| expanded glass beads | |
| MS adhesive composition with expanded | −21 dB |
| glass beads (d50 from 0.5 to 1 mm) | |
| MS adhesive composition with expanded | −19 dB |
| glass beads (d50 from 1 to 2 mm) | |
| MS adhesive composition without | −18 dB |
| expanded glass beads | |
| PSA adhesive composition with expanded | −20 dB |
| glass beads (d50 from 0.5 to 1 mm) | |
| PSA adhesive composition with expanded | −19 dB |
| glass beads (d50 from 1 to 2 mm) | |

The impact noise reduction test demonstrates that the acoustic performance of the system according to the invention is further improved when it is laid on the substrate using an adhesive comprising fillers having a density of less than 1 g/cm³, in particular expanded glass beads having a weight-median particle size (d50) of from 0.5 mm to 2 mm.

1-15. (canceled)

16. A waterproof laminated sound insulation system for flooring comprising a first outer layer, a second outer layer, and a waterproof intermediate layer interposed between the two outer layers;
said intermediate layer being a preformed plastic layer having a series of cavities on one of its two surfaces; said cavities comprising a resilient material having a Shore A hardness of from 50 to 90.

17. The waterproof laminated sound insulation system according to claim 16, wherein the resilient material is selected from the group consisting of rubber, cork, and mixtures thereof.

18. The waterproof laminated sound insulation system according to claim 17, wherein the resilient material is in the form of rubber beads having a weight-median particle size (d50) of from 0.1 to 2 mm.

19. The waterproof laminated sound insulation system according to claim 16, wherein the cavities further comprise a binder material.

20. The waterproof laminated sound insulation system according to claim 16, further comprising an adhesive layer obtained by applying an adhesive composition to one of the outer layers and/or to the substrate.

21. The waterproof laminated sound insulation system according to claim 20, wherein the adhesive composition comprises fillers having a density of less than 1.2 g/cm³.

22. The waterproof laminated sound insulation system according to claim 21, wherein the fillers having a density of less than 1.2 g/cm³ are expanded glass beads.

23. The waterproof laminated sound insulation system according to claim 16, wherein the waterproof intermediate layer is obtained from a flat layer shaped by a forming process.

24. The waterproof laminated sound insulation system according to claim 16, wherein the waterproof intermediate layer comprises a plastic material selected from the group consisting of polyolefins, polyurethane, polyvinyl chloride, ethylene/vinyl acetate copolymer, ethylene-propylene-diene terpolymer and mixtures thereof.

25. The waterproof laminated sound insulation system according to claim 24, wherein the waterproof intermediate layer comprises a plastic material selected from the group consisting of polyethylene, polypropylene, and mixtures thereof.

26. The waterproof laminated sound insulation system according to claim 16, wherein the waterproof intermediate layer has a thickness of from 1 mm to 9 mm.

27. The waterproof laminated sound insulation system according to claim 26, wherein the waterproof intermediate layer has a thickness of from 2 mm to 7 mm.

28. The waterproof laminated sound insulation system according to claim 27, wherein the waterproof intermediate layer has a thickness of from 3 mm to 6 mm.

29. The waterproof laminated sound insulation system according to claim 16, wherein the outer layers each have a thickness of from 5 μm to 5 mm.

30. The waterproof laminated sound insulation system according to claim 29, wherein the outer layers each have a thickness of from 10 μm to 3 mm.

31. The waterproof laminated sound insulation system according to claim 30, wherein the outer layers each have a thickness of from 50 μm to 2 mm.

32. The waterproof laminated sound insulation system according to claim 16, wherein the outer layers are firmly attached to the waterproof intermediate layer.

33. The waterproof laminated sound insulation system according to claim 32, wherein the outer layers are heat-sealed to the waterproof intermediate layer.

34. A sound insulation kit comprising:
a waterproof laminated system comprising a first outer layer, a second outer layer, and a waterproof intermediate layer interposed between the two outer layers; said intermediate layer being a preformed plastic layer having a series of cavities on one of its two surfaces; said cavities comprising a resilient material having a Shore A hardness of from 50 to 90; and
an adhesive composition.

35. A method for laying a waterproof laminated sound insulation system, comprising the following steps:
providing a waterproof laminated system comprising a first outer layer, a second outer layer, and a waterproof intermediate layer interposed between the first outer layer and the second outer layer; said intermediate layer being a preformed plastic layer having a series of cavities on one of its two surfaces; said cavities comprising a resilient material having a Shore A hardness of from 50 to 90;
determining the orientation of the waterproof laminated system;
applying an adhesive composition to the lower outer layer to be positioned facing the substrate or directly on the substrate;
laying the waterproof laminated system on the substrate and adhering the lower outer layer to the substrate;
applying an adhesive mortar to the upper outer layer; and
laying the floor covering and adhering it to the top outer layer.
